(19) United States
(12) Patent Application Publication
(10) Pub. No.: US 2008/0231106 A1
(43) Pub. Date: Sep. 25, 2008

(54) Bicycle wheel rim

(75) Inventor: Chao-Ying Chen, Shan-Shang Hsiang (TW)

Correspondence Address: THE WEBB LAW FIRM, P.C., 700 KOPPERS BUILDING, 436 SEVENTH AVENUE, PITTSBURGH, PA, 15219, US

(73) Assignee: ALEX GLOBAL TECHNOLOGY, INC., Shan-Shang Hsiang (TW)

(21) Appl. No.: 11/726,841

(22) Filed: Mar. 23, 2007

(51) Int. Cl. B60B 21/00

(52) U.S. Cl. 301/95.106

(57) ABSTRACT

A bicycle wheel rim includes an annular rim body having a rim axis, and including left and right annular side walls, a pair of annular oblique walls, an annular base wall, left and right annular connecting walls, and a pair of annular tire-retaining ribs. Each of the left and right annular side walls has a radial outer edge. Each of the oblique walls extends obliquely from a respective one of the side walls toward the other one of the side walls. The base wall interconnects the oblique walls and has a radial outer side. Each of the left and right annular connecting walls extends from the base wall to connect to a respective one of the side walls. A radial distance between the radial outer side of the base wall and the radial outer edges,of the side walls ranges from 8.5 millimeters to 12.5 millimeters.

### BACKGROUND OF THE INVENTION

1. Field of the Invention

The invention relates to a wheel rim, more particularly to a bicycle wheel rim.

2. Description of the Related Art

An ideal bicycle wheel rim requires some features, including a relatively good rigidity, a relatively high strength, a relatively light weight, and a structure which facilitates insertion of a tire but which makes it difficult for the tire to be taken off. However, these features usually contradict one another. As shown in FIG. 1, a conventional bicycle wheel rim 10 includes a pair of annular side walls 101, an annular base wall 102 interconnecting radial inner ends of the side walls 101, a pair of annular first extending walls 104 extending obliquely from the base wall 102 to a respective one of the sidewalls 101, and a pair of annular second extending walls 103 extending from a respective one of the first extending walls 104 to a corresponding one of the side walls 101. The middle portion of the base wall 102 protrudes radially and outwardly relative to the radial inner ends of the side walls 101. The presence of double extending walls results in a relatively high strength but a relatively heavy weight for the wheel rim. Moreover, the design of double extending walls also results in a relatively long radial depth (H) of an interior tire-retaining space Such that, once an inserted tire 106 is punctured, a consequent deformation thereof can cause the tire 106 to be taken off easily. Furthermore, each of the extending walls 103 has a connecting segment 105 radially perpendicular to the base wall 102. The design of the connecting segments 105 hinders sliding of tire beads 107 of the tire 106 during inflation.

As shown in FIG. 2, another conventional bicycle wheel rim 20 includes a pair of annular side walls 201, an annular base wall 202 interconnecting radial inner edges of the side walls 201 and forming an arch configuration, an annular reinforcing wall 203 interconnecting radial outer parts of the side walls 201, and a connecting wall 204 interconnecting the reinforcing wall 203 and the connecting wall 204. The annular base wall 202 is formed with a plurality of spoke fixing holes 200, through each of which a spoke fixing component 21 extends. Each of the annular side walls 201 has a thicker part at a radial inner part that is connected to the base wall 202. The double-layer, i.e., the reinforcing wall 203 and the base wall 202, and the thicker parts of the annular side walls 201 result in a higher strength. Although the radial depth (H) of the interior tire-retaining space of this conventional wheel rim 20 is shorter than that of the previous conventional bicycle wheel rim 10, the disposition of the reinforcing wall 203 and the base wall 204 results in a relatively heavy weight for the conventional wheel rim 20.

### SUMMARY OF THE INVENTION

Therefore, the object of the present invention is to provide a bicycle wheel rim that has a relatively high strength and a relatively light weight, that facilitates insertion of a tire but makes it difficult for the tire to be taken off, and that facilitates positioning of tire beads during inflation.

According to the present invention, a bicycle wheel rim for retaining a tire and a plurality of spokes comprises an annular rim body. The rim body has a horizontally disposed rim axis, and includes left and right annular side walls, a pair of annular oblique walls, an annular base wall, left and right annular connecting walls, and a pair of annular tire-retaining ribs. The left and right annular side walls are spaced apart from each other and surround the rim axis. Each of the side walls has a radial inner edge and a radial outer edge relative to the rim axis. Each of the oblique walls extends obliquely from a respective one of the side walls toward the other one of the side walls in radial outward directions relative to the rim axis, and has a first edge connected to the radial inner edge of the respective one of the side walls and a second edge opposite to the first edge. The first edges of the oblique walls are disposed on an imaginary cylindrical plane. The base wall interconnects the second edges of the oblique walls, and is formed with a plurality of spoke fixing holes. The base wall has a radial outer side opposite to the rim axis, and opposite left and right ends. The left annular connecting wall extends from the left end of the base wall to connect to the left annular side wall. The right annular connecting wall extends from the right end of the base wall to connect to the right annular side wall. Each of the left and right annular connecting walls is disposed radially outward relative to a respective one of the oblique walls, and cooperates with a connected one of the side walls and the respective one of the oblique walls to define an annular hole. Each of the annular tire-retaining ribs protrudes from the radial outer edge of a respective one of the side walls toward the other one of the side walls. A radial distance between the radial outer side of the base wall and the radial outer edges of the side walls ranges from 8.5 millimeters to 12.5 millimeters.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional schematic view of a conventional bicycle wheel rim;

FIG. 2 is a sectional schematic view of another conventional bicycle wheel rim;

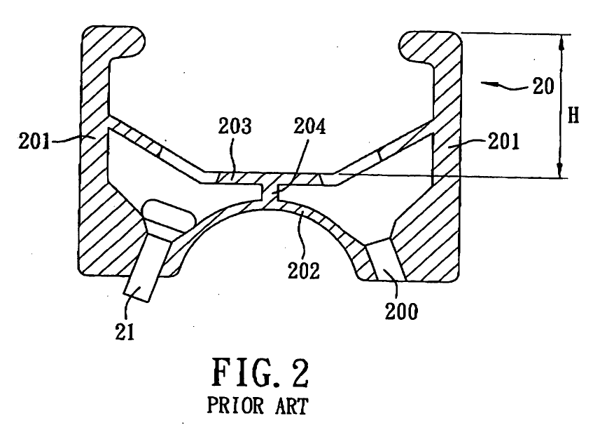

FIG. 3 is a sectional schematic view of a preferred embodiment of a bicycle wheel rim according to the invention, and a tire before inflation;

FIG. 4 is a view similar to FIG. 3, but illustrating the tire after inflation;

FIG. 5 is a sectional view of the preferred embodiment, illustrating force distribution; and

FIG. 6 is a partly sectional schematic view of the preferred embodiment.

### DETAILED DESCRIPTION OF THE PREFERRED EMBODIMENT

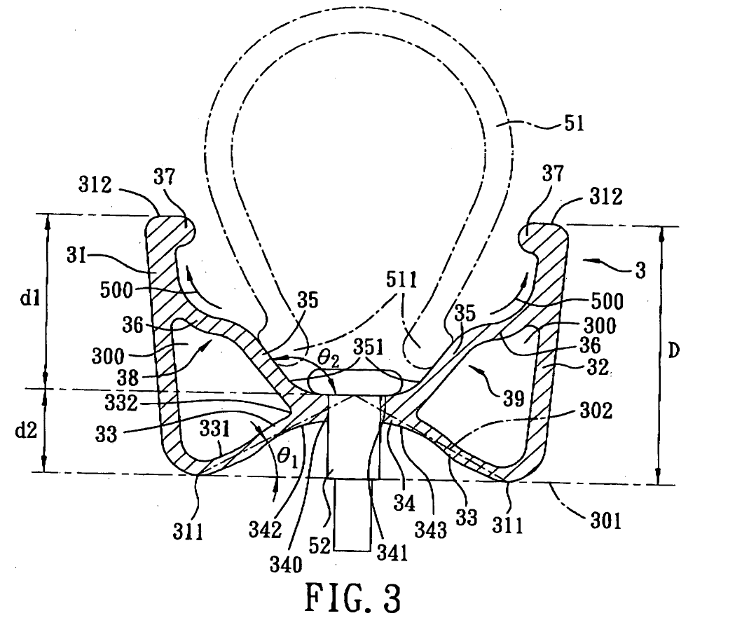

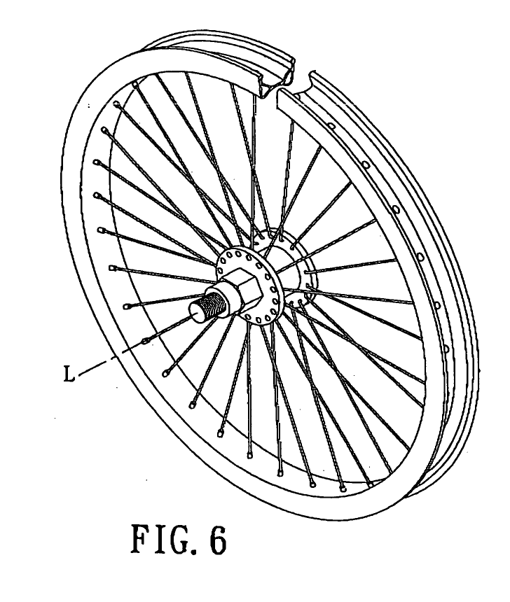

As shown in FIGS. 3, 4, and 6, the preferred embodiment of a bicycle wheel rim according to the present invention is for retaining a tire 51 and a plurality of spoke fixing components 52. The preferred embodiment of the bicycle wheel rim comprises an annular rim body 3 and a pair of connecting rods (not shown) inserted in and interconnecting adjacent ends of the rim body 3 in a conventional manner. The annular rim body 3 has a horizontally disposed rim axis (see FIG. 6), and includes left and right annular side walls 31, 32, a pair of annular oblique walls 33, an annular base wall 34, left and right annular connecting walls 38, 39, and a pair of annular tire-retaining ribs 37.

The left and right annular sidewalls 31, 32 are spaced apart From each other and surround the rim axis. Each of the side walls 31, 32 has a radial inner edge 311 and a radial outer edge 312 relative to the rim axis.

Each of the annular oblique walls 33 extends obliquely from a respective one of the annular side walls 31, 32 toward the other one of the annular side walls 31, 32 in radial outward directions relative to the rim axis. Each of the annular oblique walls 33 has a first edge 331 connected to the radial inner edge 311 of the respective one of the annular side walls 31, 32 and a second edge 332 opposite to the first edge 331. The first edges 331 of the annular oblique walls 33 are disposed on an imaginary cylindrical plane 301.

The annular base wall 34 interconnects the second edges 332 of the annular oblique walls 33, and cooperates with the oblique walls 33 to form an arch configuration that opens toward the rim axis. The annular base wall 34 has a radial outer side 341 opposite to the rim axis, and opposite left and right ends 342, 343. The annular base wall 34 is formed with a plurality of spoke fixing holes 340 in a center thereof.

The left annular connecting wall 38 extends from the left end 342 of the annular base wall 34 to connect to the left annular side wall 31. The right annular connecting wall 39 extends from the right end 343 of the annular base wall 34 to connect to the right annular side wall 32. Each of the annular connecting walls 38, 39 is disposed radially outward relative to a respective one of the annular oblique walls 33, and cooperates with a connected one of the annular side walls 31, 32 and the respective one of the annular oblique walls 33 to define an annular hole 300 for insertion of a respective connecting rod (not shown). Each of the annular connecting walls 38, 39 includes an extending segment 35 that extends obliquely from the annular base wall 34, and a connecting segment 36 that extends from the extending segment 35 to the respective one of the annular side walls 31, 32.

Each of the annular tire-retaining ribs 37 protrudes from the radial outer edge 312 of a respective one of the annular side walls 31, 32 toward the other one of the annular side walls 31, 32.

According to the invention, a radial distance (d1) between the radial outer side 341 of the annular base wall 34 and each of the radial outer edges 312 of the annular side walls 31, 32 ranges from 8.5 millimeters to 12.5 millimeters, and a radial length (D) of each of the annular side walls 31, 32 relative to the rim axis ranges between 12 millimeters and 20 millimeters. Preferably, the radial distance (d1) ranges from 10 millimeters to 12 millimeters, and the radial length (D) ranges from 14 millimeters to 17 millimeters. In this embodiment, the radial distance (d1) is 12 millimeters, and the radial length (D) is 16 millimeters. If the radial distance (d1) is shorter than 8.5 millimeters, insertion of the tire 51 will not be easy. However, if the radial distance (d1) is longer than 12.5 millimeters, the inserted tire 51 may be taken off the rim body 3 easily.

There are two imaginary connecting lines 302, each of which extends from a center of the radial outer side 341 of the annular base wall 34, extends along a respective one of the oblique walls 33, terminates at the first edge 331 of the respective oblique wall 33, and forms a first angle (θ₁) with the imaginary cylindrical plane 301. The extending segment 35 of each of the annular connecting walls 38, 39 has a radial outer side 351 forming a second angle (θ₂) with the radial outer side 341 of the annular base wall 34. The annular side walls 31, 32 cooperate with the annular oblique walls 33, the annular base wall 34, and the annular connecting wall 38, 39 to form a symmetrical truss structure with a relatively high strength.

According to this invention, the first angle (θ₁) ranges between 26 and 36 degrees, and preferably ranges between 30 and 32 degrees. In this embodiment, the first angle (θ₁) is 31 degrees. When the first angle (θ₁) is smaller than 26 degrees, a relatively long radial distance (d1) between the radial outer side 341 of the annular base wall 34 and each of the radial outer edges 312 of the annular side walls 31, 32 will result such that the truss structure of the rim body 3 is not able to convey forces from the tire 51 effectively to the annular side walls 31, 32. On the other hand, when the first angle (θ₁) is larger than 36degrees, the extending segments 35 of the annular connecting walls 38 and 39 will be relatively steep such that the tire beads 511 of the tire 51 that abut against the extending segments 35 are not able to slide smoothly thereon during inflation. In addition, when the first angle (θ₁) is larger than 36 degrees, a relatively long radial distance (d2) between the radial outer side 341 of the annular base wall 34 and the imaginary cylindrical plane 301 will result, thereby making it difficult to clamp the spoke fixing components 52.

According to this invention, the second angle (θ₂) ranges between 123 and 133 degrees, and preferably ranges between 127 and 129 degrees. In this embodiment, the second angle (θ₂) is 128 degrees. If the second angle (θ₂) is larger than 133 degrees, the strength of the truss structure of the rim body 3 will be lowered. On the other hand, if the second angle (θ₂) is smaller than 123 degrees, the tire beads 511 that abut against the extending segments 35 are not able to slide thereon during inflation.

From the aforementioned description, the advantages of the bicycle wheel rim according to the present invention can be summarized as follows:

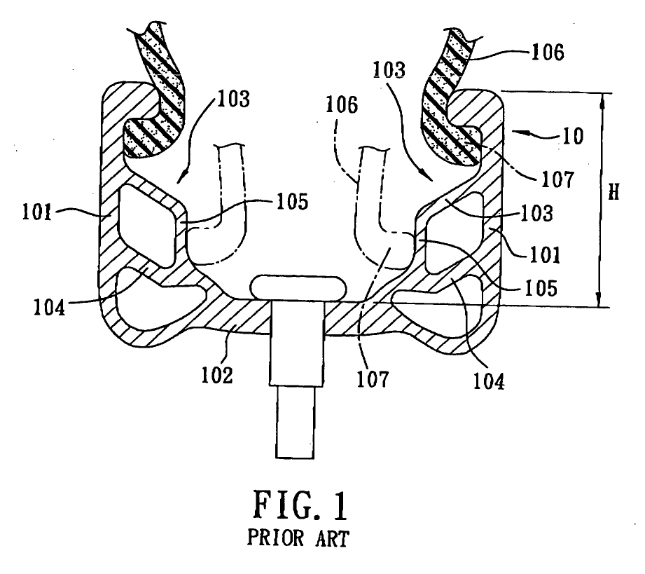

1. By virtue of the annular oblique walls 33, the radial distance (d1) between the radial outer side 341 of the annular base wall 34 and each of the radial outer edges 312 of the annular side walls 31, 32 is shorter than the radial depth (H) of the interior tire-retaining space of the first conventional wheel rim 10 shown in FIG. 1. Therefore, the interior space of the present invention is smaller, and the deformation of the tire is 51 that may cause the tire 51 to be taken off the wheel rim will be effectively reduced.

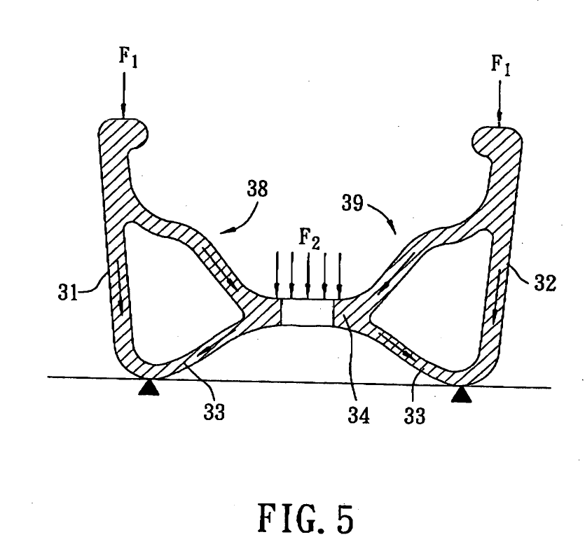

2. The configuration of the present invention is designed as a truss structure, which has a higher strength than the prior art. As shown in FIG. 5 when the rim body 3 is bearing a force in the radial direction, components of force (F1) will be transmitted evenly from the annular side walls 31, 32 through the annular connecting walls 38, 39 and the annular base wall 34, and to the annular oblique walls 33. Finally, the components of force (F1) will be borne evenly by the rim body 3 at parts where the annular oblique walls 33 are connected to the annular side walls 31, 32 (marked by the symbols ▴). Similarly, forces (F2) applied by the spoke fixing component 52 are borne evenly by the rim body 3. While maintaining high strength, the rim body 3 can be manufactured with thinner elements to reduce its weight.

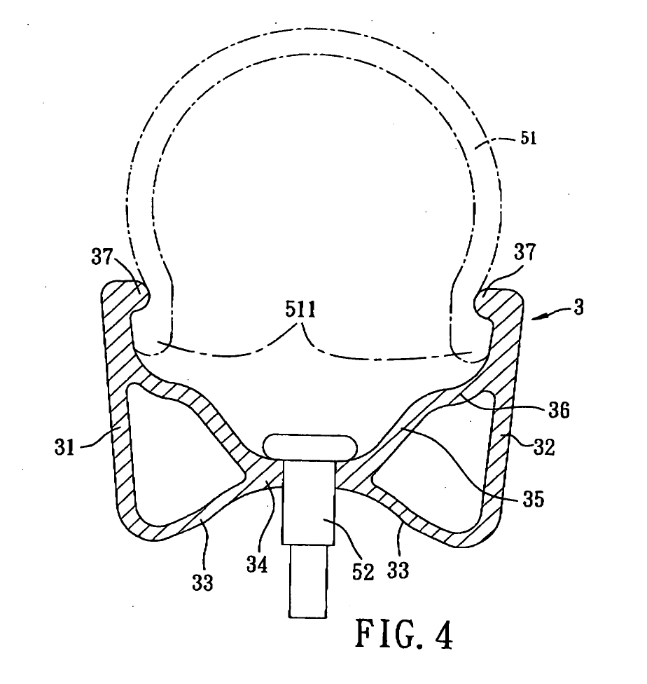

3. During inflation, the tire beads 511 of the tire 51 can slide respectively and smoothly on the annular connecting walls 38, 39 along the directions 500 (as indicated by the arrows in FIG. 3) toward the tire-retaining ribs 37, and be retained in the rim body 3 by the tire-retaining ribs 37 (see FIG. 4).

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A bicycle wheel rim for retaining a tire and a plurality of spokes, said bicycle wheel rim comprising:
an annular rim body having a horizontally disposed rim axis and including
left and right annular side walls that are spaced apart from each other and that surround the rim axis, each of said side walls having a radial inner edge and a radial outer edge relative to the rim axis,
a pair of annular oblique walls, each of which extends obliquely from a respective one of said side walls toward the other one of said side walls in radial outward directions relative to the rim axis, and each of which has a first edge connected to said radial inner edge of the respective one of said side walls and a second edge opposite to said first edge, said first edges of said oblique walls being disposed on an imaginary cylindrical plane,
an annular base wall that interconnects said second edges of said oblique walls, that has a radial outer side opposite to the rim axis, that has opposite left and right ends, and that is formed with a plurality of spoke fixing holes,
left and right annular connecting walls, said left annular connecting wall extending from said left end of said base wall to connect to said left annular side wall, said right annular connecting wall extending from said right end of said base wall to connect to said right annular side wall, each of said left and right annular connecting walls being disposed radially outward relative to a respective one of said oblique walls, and cooperating with a connected one of said side walls and the respective one of said oblique walls to define an annular hole, and
a pair of annular tire-retaining ribs, each of which protrudes from said radial outer edge of a respective one of said side walls toward the other one of said side walls;
wherein a radial distance between said radial outer side of said base wall and said radial outer edges of said side walls ranges from 8,5 millimeters to 12.5 millimeters.

2. The bicycle wheel rim as claimed in claim 1, wherein said base wall cooperates with said oblique walls to form an arch configuration that opens toward the rim axis.

3. The bicycle wheel rim as claimed in claim 1, wherein each of two imaginary connecting lines, each extending from a center of said radial outer side of said base wall, extending along a respective one of said oblique walls, and terminating at said first edge of the respective one of said oblique walls, forms a first angle with the imaginary cylindrical plane that ranges between 26 and 36 degrees.

4. The bicycle wheel rim as claimed in claim 3, wherein each of said connecting walls includes an extending segment that extends obliquely from said base wall, and a connecting segment that extends from said extending segment to the respective one of said side walls, said extending segment having a radial outer side forming a second angle with said radial outer side of said base wall that ranges from 123 to 133 degrees.

5. The bicycle wheel rim as claimed in claim 4, wherein:
the radial distance between said radial outer side of said base wall and said radial outer edges of said side walls ranges from 10 millimeters to 12 millimeters;
the first angle ranges between 30 and 32 degrees; and
the second angle ranges from 127 to 129 degrees.

6. The bicycle wheel rim as claimed in claim 5, wherein the radial distance between said radial outer side of said base wall and said radial outer edges of said side walls is 12 millimeters, the first angle is 31 degrees, and the second angle is 128 degrees.

7. The bicycle wheel rim as claimed in claim 1, wherein each of said connecting walls includes an extending segment that extends obliquely from said base wall, and a connecting segment that extends from said extending segment to the respective one of said side walls, said extending segment having a radial outer side forming an angle with said radial outer side of said base wall that ranges from 123 to 133 degrees.

8. The bicycle wheel rim as claimed in claim 1, wherein a radial length of each of said side walls relative to the rim axis ranges between 12 millimeters and 20 millimeters.

9. The bicycle wheel rim as claimed in claim 8, wherein the radial distance between said radial outer side of said base wall and said radial outer edges of said side walls ranges from 10 millimeters to 12 millimeters, and the radial length of each of said side walls ranges from 14 millimeters to 17 millimeters.

10. The bicycle wheel rim as claimed in claim 9, wherein the radial distance between said radial outer side of said base wall and said radial outer edges of said side walls is 12 millimeters, and the radial length of each of said side walls is 16 millimeters.

11. The bicycle wheel rim as claimed in claim 1, wherein said spoke fixing holes are formed in a center of said base wall.
